(19) United States
(12) Patent Application Publication
(10) Pub. No.: US 2017/0173827 A1
(43) Pub. Date: Jun. 22, 2017

(54) PROCESS FOR PRODUCING A PLASTIC PART

(71) Applicant: ILLINOIS TOOL WORKS INC., Glenview, IL (US)

(72) Inventor: Elmar FRIES, Roettingen (DE)

(21) Appl. No.: 15/310,276

(22) PCT Filed: Mar. 11, 2015
(86) PCT No.: PCT/US2015/019826

§ 371 Date: Nov. 10, 2016

(30) Foreign Application Priority Data
May 16, 2014 (DE) 10 2014 106 958.7

(51) Int. Cl. B29C 44/04; B29C 35/16; B29C 44/34

(52) U.S. Cl. CPC B29C 44/0461; B29C 44/3415; B29C 35/16; B29K 2105/043

(57) ABSTRACT

A process for producing a plastic part for vehicles in an injection molding process, characterized by the following steps:
a first plastic charge is injected in the plasticized state into the mold cavity of an injection mold,
subsequently, a second plastic charge is injected together with a blowing agent into the mold cavity, the blowing agent leading to the expansion of the second plastic charge injected into the mold cavity, as a result of which the still fluid first plastic charge is pressed from the inside against the walls which delimit the mold cavity of the injection mold,
wherein, after the first plastic charge has been injected, a coolant is conducted through the walls which delimit the mold cavity of the injection mold, as a result of which the walls which delimit the mold cavity of the injection mold are actively cooled.

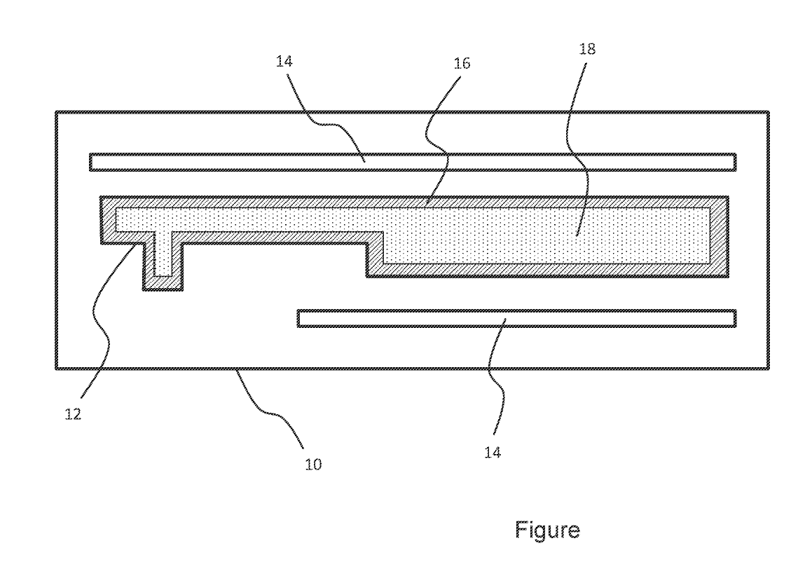

### RELATED APPLICATIONS

The present application is a National Phase of International Application Number PCT/US2015/019826, filed Mar. 11, 2015, and claims priority to German Application Number 10 2014 106 958.7, filed May 16, 2014.

### BACKGROUND

The invention relates to a process for producing a plastic part for vehicles, in particular for automobiles.

For visual reasons, it may be desirable to subject plastic parts to surface finishing, for example painting or chrome-plating. For this, it is decisive that the surface of the plastic parts does not have any defects, for example warpage or sinking. Plastic parts of this type are often produced in a plastic injection molding process. Surface defects can then arise, for example, in the course of the cooling and associated shrinkage of the plastic. In order to avoid surface defects, it has already been proposed to feed a blowing agent to the plastic injected into the injection mold, said blowing agent expanding the plastic in the injection mold. The surface of the plastic part produced then has porosities, however, which in turn are unacceptable for a subsequent chrome-plating operation.

By way of example, DE 200 18 615 U1 discloses an external vehicle door handle made of a thermoplastic material which has a tightly closed or closed-pore outer skin formed by crosslinking. This is achieved by electron beam crosslinking. This external vehicle door handle can have a foamed core and a closed outer skin, with chemical or physical blowing agents being added to the thermoplastic material before or during the shaping process. It was also proposed in said document to manufacture the external vehicle door handle from a material pairing, specifically a functional plastic component for the handle and a decorative plastic component for an outer decorative layer. This can be effected in a two-component injection molding process or in a sandwich structure.

For achieving a high surface quality in plastic parts, the gas-assisted injection molding process is moreover known, in which, after the plastic has been introduced into the mold cavity, gas is introduced at a high pressure into the plastic and presses the plastic against the inner walls of the mold cavity. The gas-assisted process is only suitable for certain types of plastic parts, however.

The processes known for producing plastic parts either do not result in the surface quality required for subsequent chrome-plating or are complex in terms of the process sequence and/or the process duration.

### SUMMARY

Proceeding from the prior art mentioned, the invention is based on providing a process of the type specified in the introduction which achieves a high surface quality of the plastic parts with little complexity.

### BRIEF DESCRIPTION OF THE DRAWINGS

The FIGURE depicts in schematic form, an injection mold having a plastic part produced by the process according to the invention located therein.

### DESCRIPTION OF SOME EMBODIMENTS

The invention can achieve utilitarian value by virtue of a process for producing a plastic part for vehicles in an injection molding process, characterized by the following steps:
a first plastic charge is injected in the plasticized state into the mold cavity of an injection mold,
subsequently, a second plastic charge is injected together with a blowing agent into the mold cavity, the blowing agent leading to the expansion of the second plastic charge injected into the mold cavity, as a result of which the still fluid first plastic charge is pressed from the inside against the walls which delimit the mold cavity of the injection mold,
wherein, after the first plastic charge has been injected, a coolant is conducted through the walls which delimit the mold cavity of the injection mold, as a result of which the walls which delimit the mold cavity of the injection mold are actively cooled, and
wherein, after an adequate dimensional stability has been reached, the plastic part which is reproduced in the mold cavity is removed from the injection mold.

According to the invention, in a first process step, a first plastic charge is injected in the fluid state into the mold cavity of the injection mold. Subsequently, a second plastic charge is injected together with a blowing agent into the center of the mold cavity, for example. The blowing agent leads to the expansion of the second plastic charge. This expansion in turn presses the first plastic charge, which at this point in time is still fluid, against the walls of the injection mold which delimit the mold cavity. In particular, after the complete filling of the mold cavity and the rapid drop in pressure in the mold cavity, small bubbles, in particular small air bubbles, form in the second plastic charge, and counteract shrinkage. Sites of sinking, warpage and internal stresses of the plastic part are avoided to the greatest possible extent. What is formed is a plastic part with a compact, closed outer skin with a flawless surface and a foamed core.

Only the second plastic charge which forms the core of the plastic part comprises the blowing agent. The outer skin, formed by the first plastic charge, does not comprise any blowing agent, and therefore porosity of the surface of the plastic part is reliably avoided. In this way, it is possible to produce even complex shapes with an extremely high surface quality by a simple process. A reduced weight of the parts, a low internal mold pressure and a reduction of repair costs with respect to the injection molding tools are achieved with short cycle times.

The blowing agent can be added to the second plastic charge already before the latter is injected into the mold cavity, for example it can already be added to the granulated plastic before the plastic is plasticized. It is also possible, however, for the blowing agent to be injected into the mold cavity together with the second plastic charge during the course of the injection of the second plastic charge. In this case, the blowing agent can be added in the region in which the second plastic charge is fed to the mold cavity.

According to the invention, it is moreover the case that, after the first plastic charge has been injected, a coolant is conducted through the walls which delimit the mold cavity of the injection mold. As a result, the walls which delimit the mold cavity are actively cooled. This active cooling (also referred to as a variotherm process) achieves rapid cooling of the outer skin of the plastic part, as a result of which the blowing agent can diffuse particularly uniformly in the core like a foam. Further improved surface qualities are achieved by the use of active cooling. At the same time, the cycle time is reduced, since the dimensional stability required for the subsequent removal of the plastic part from the injection mold is achieved more rapidly by the active cooling.

In summary, the surface quality of the plastic parts produced is improved. Sites of sinking and also internal stresses and warpage are reduced to the greatest possible extent. The dimensional stability is improved, and an increased rigidity of the plastic part produced is achieved. The plastic parts produced by the process according to the invention are therefore optimally suitable for subsequent finishing, such as chrome-plating or painting. The foamed core of the plastic part additionally achieves a saving in weight and material and therefore a reduction in material costs. The reduced cycle times give rise to an increased output of plastic parts. Moreover, the internal mold pressure is reduced, the mold repairs are reduced and an increased machine efficiency is achieved.

It is possible that the conduction of coolant through the walls which delimit the mold cavity of the injection mold is started after the first plastic charge has been injected and before the second plastic charge is injected into the mold cavity. It is also possible that the conduction of coolant through the walls which delimit the mold cavity of the injection mold is started after the second plastic charge has been injected into the mold cavity.

According to a further configuration, it can be provided that the coolant is conducted through the walls which delimit the mold cavity of the injection mold until at least the first plastic charge has a dimensional stability which is sufficient for the removal of the plastic part from the injection mold. The active cooling of the walls which delimit the mold cavity is preferably continued until the first and the second plastic charge have a sufficient dimensional stability. In this context, sufficient dimensional stability means that the plastic part can be removed without the risk of deformation during the course of removal.

According to a particularly practical configuration, the coolant can be a cooling liquid, in particular water or oil controlled to a predefined cooling temperature. The coolant can be pumped in a circuit through temperature-control ducts in the walls which delimit the mold cavity of the injection mold. In this way, the heat is dissipated continuously from the walls which delimit the mold cavity. Outside the walls which delimit the mold cavity, the coolant can be conducted through a cooler, such that a constant temperature of the coolant is ensured.

According to a further configuration, it can be provided that the walls which delimit the mold cavity of the injection mold are actively heated before the coolant is conducted through the walls which delimit the mold cavity of the injection mold. This configuration achieves a particularly uniform distribution in particular of the first plastic charge in the mold cavity, it being ensured that the first plastic charge rests completely against the walls which delimit the mold cavity.

The walls which delimit the mold cavity can be actively heated by conducting a heating medium through these walls. In turn, the heating medium can be a heating liquid, in particular water or oil controlled to a predefined heating temperature. However, the heating medium can also be a heating gas, for example carbon dioxide (CO₂). In turn, the heating medium can be pumped in a circuit through temperature-control ducts in the walls which delimit the mold cavity of the injection mold, in particular through the same temperature-control ducts through which the coolant can subsequently be pumped. In this case, too, the heating medium can be pumped through a heating device outside the walls which delimit the mold cavity, such that it maintains a constant heating temperature. It is also possible that the walls which delimit the mold cavity of the injection mold are actively heated by heating elements, in particular electrical heating elements, arranged in the walls which delimit the mold cavity of the injection mold.

The blowing agent used can be a chemical blowing agent. During what is termed chemical foaming, the blowing agent is fed to the plastic before it is injected into the mold cavity, in particular already to the granulated plastic, before the granules (together with the fed blowing agent) are plasticized by the action of heat. During the course of the processing of the plastic, in particular the action of heat and the rapid injection of the plastic into the mold cavity, the chemical blowing agent substances fed are decomposed and react with the evolution of a gas, which then leads to the expansion of the second plastic charge.

According to an alternative configuration, the blowing agent used can be a physical blowing agent. During what is termed physical foaming, a gas, for example nitrogen (N₂) or carbon dioxide (CO₂), is fed under pressure to the plastic of the second plastic charge either in the plasticizing unit, in which the plastic is melted for injection into the mold cavity, or during the course of injection into the mold cavity. During the course of further processing, in particular the action of heat and the rapid injection into the mold cavity, the fed gas expands and therefore leads to the expansion of the second plastic charge.

The first plastic charge and the second plastic charge can be formed from different plastics. The process according to the invention can be in particular a two-component injection molding process. As a result of this, the plastics used for the first plastic charge and for the second plastic charge can be adapted flexibly to the requirements during operation. Alternatively, it is also possible, however, that the plastics used for the first and second plastic charges are identical (except for an added blowing agent).

The plastic part produced by the process according to the invention can be a handle or an (internal or external) door handle of an automobile. After the injection molding process, the plastic part produced according to the invention can be subjected to surface finishing, for example chrome-plating or painting. This is effected in particular after the plastic part has been removed from the mold cavity of the injection mold.

The invention will be explained in more detail hereinbelow on the basis of a FIGURE. The single FIGURE shows, in greatly schematic form, an injection mold having a plastic part produced by the process according to the invention located therein.

Reference sign 10 designates an injection mold, which defines a mold cavity 12 by virtue of a plurality of walls. The walls of the injection mold 10 have temperature-control ducts 14.

The FIGURE shows, in the mold cavity 12, a plastic part having a closed outer skin 16 resting against the inner walls of the mold cavity 12 and a foamed core 18 surrounded completely by the outer skin 16. The plastic part can be, for example, a door handle of an automobile.

For production, in a first step, a first plastic charge made of a first plastic material which forms the outer skin 16 was injected in the plasticized state into the mold cavity 12. Subsequently, a second plastic charge made of a second plastic material which forms the core 18 was injected together with a blowing agent into the mold cavity 12. The blowing agent leads to the expansion of the second plastic charge which forms the core 18, as a result of which the first plastic charge which forms the outer skin 16 is pressed in the still fluid state against the walls of the injection mold 10 which delimit the mold cavity 12. Before the first plastic charge was injected, a heating liquid, for example water heated to a predefined temperature, was pumped in a circuit through the temperature-control ducts 14. After the first plastic charge had been injected, cooling liquid cooled to a predefined temperature, in particular cooling water, was pumped in turn in a circuit through the temperature-control ducts 14.

In the example shown, a suitable chemical blowing agent was already added to the granules which form the second plastic material in the still non-plasticized state. Said blowing agent was then heated together with the granules which form the second plastic material to achieve the flowability required for injection. The first plastic material which forms the outer skin 16 and the second plastic material which forms the core 18 are different plastic materials.

After an adequate dimensional stability has been reached, the injection mold 10 is opened and the finished plastic part is removed. On account of its high surface quality, the plastic part can then be subjected to subsequent finishing, for example chrome-plating or painting.

1. A process for producing a plastic part for vehicles in an injection molding process, including the following steps:
a first plastic charge is injected in the plasticized state into the mold cavity of an injection mold,
subsequently, a second plastic charge is injected together with a blowing agent into the mold cavity, the blowing agent leading to the expansion of the second plastic charge injected into the mold cavity, as a result of which the still fluid first plastic charge is pressed from the inside against the walls which delimit the mold cavity of the injection mold,
wherein, after the first plastic charge has been injected, a coolant is conducted through the walls which delimit the mold cavity of the injection mold, as a result of which the walls which delimit the mold cavity of the injection mold are actively cooled, and
wherein, after an adequate dimensional stability has been reached, the plastic part which is reproduced in the mold cavity is removed from the injection mold.

2. The process as claimed in claim 1, wherein the conduction of coolant through the walls which delimit the mold cavity of the injection mold is started after the first plastic charge has been injected and before the second plastic charge is injected into the mold cavity.

3. The process as claimed in claim 1, wherein the conduction of coolant through the walls which delimit the mold cavity of the injection mold is started after the second plastic charge has been injected into the mold cavity.

4. The process as claimed in claim 1, wherein the coolant is conducted through the walls which delimit the mold cavity of the injection mold until at least the first plastic charge has a dimensional stability which is sufficient for the removal of the plastic part from the injection mold.

5. The process as claimed in claim 1, wherein the coolant is a cooling liquid, in particular water or oil controlled to a predefined cooling temperature.

6. The process as claimed in claim 1, wherein the coolant is pumped in a circuit through temperature-control ducts in the walls which delimit the mold cavity of the injection mold.

7. The process as claimed in claim 1, wherein the walls which delimit the mold cavity of the injection mold are actively heated before the coolant is conducted through the walls which delimit the mold cavity of the injection mold.

8. The process as claimed in claim 7, wherein the active heating is carried out by conducting a heating medium through the walls which delimit the mold cavity of the injection mold.

9. The process as claimed in claim 8, wherein the heating medium is a heating liquid, in particular water or oil controlled to a predefined heating temperature, or a heating gas.

10. The process as claimed in claim 8, wherein the heating medium is pumped in a circuit through temperature-control ducts in the walls which delimit the mold cavity of the injection mold.

11. The process as claimed in claim 7, wherein the walls which delimit the mold cavity of the injection mold are actively heated by heating elements, in particular electrical heating elements, arranged in the walls which delimit the mold cavity of the injection mold.

12. The process as claimed in claim 1, wherein the blowing agent used is a chemical blowing agent.

13. The process as claimed in claim 1, wherein the blowing agent used is a physical blowing agent.

14. The process as claimed in claim 1, wherein the first plastic charge and the second plastic charge are formed from different plastics.

15. The process as claimed in claim 1, wherein the plastic part which is produced is chrome-plated and/or painted after the injection molding process.
